(19) United States
(12) Patent Application Publication
(10) Pub. No.: US 2009/0123120 A1
(43) Pub. Date: May 14, 2009

(54) Stimulated raman scattering suppressing waveguide configuration

(76) Inventor: Peter D. Dragic, Chicago, IL (US)

Correspondence Address: PATTI, HEWITT & AREZINA LLC, ONE NORTH LASALLE STREET, 44TH FLOOR, CHICAGO, IL, 60602, US

(21) Appl. No.: 12/291,210

(22) Filed: Nov. 7, 2008

Related U.S. Application Data
(60) Provisional application No. 61/002,481, filed on Nov. 8, 2007.

(51) Int. Cl. G02B 6/02; G02B 6/00

(52) U.S. Cl. 385/123; 385/144

(57) ABSTRACT

An apparatus in one example has: a fiber having a representative refractive index profile, the refractive index profile having at least a core and a pedestal; and the fiber having a modal index in the core that is greater than a modal index of the pedestal at a predetermined signal wavelength. The fiber may also have a cladding, and may have a significantly increased index of refraction over a cladding material of the cladding to reduce effects of Stimulated Raman Scattering.

### TECHNICAL FIELD

The invention relates in general to waveguides, and more particularly, to a waveguide configuration, which is designed to suppress Stimulated Raman Scattering (SRS).

### BACKGROUND

SRS is a commonly known effect, which can lead to undesirable effects in waveguides that are carrying light. It would be desirable to suppress SRS in waveguide configurations.

As an example, Yb and Er co-doped laser fibers normally have a core that is heavily doped with Yb (up to 5 wt % of its oxide), Er (up to 0.5 wt % of its oxide), and P (up to 10 mol % of its oxide). For a silica fiber, this level of doping increases the index of refraction by up to 15×10⁻³. For fibers that have a large diameter, such as large mode area (LMA) fibers for some control of nonlinearities, this usually leads to a highly multimode fiber.

In order to reduce the number of modes in the core, “pedestal” fibers have been developed. To summarize this structure, an additional cladding is situated between the core and original cladding in order to bring the effective numerical aperture (NA) of the core down. A cross-sectional refractive index profile (RIP) of this fiber is shown in FIG. 1.

In order for an optical mode to be considered “guided,” its effective index of refraction should be greater than that of a surrounding cladding. For the pedestal fiber of FIG. 1, all the modes of the system that are guided predominantly in the core have an index of refraction that is less than the core layer but greater than that of the pedestal layer. Optical modes that are predominantly guided in the pedestal have an index of refraction greater than that of the cladding and less than that of the pedestal layer. All of these modes are guided since they all have an effective index that is greater than that of the outer cladding layer.

If a mode in the core exists where its effective index of refraction is less than that of the pedestal, this mode is still considered a guided mode, as long as its effective index is greater than that of the outer cladding (pure silica in the example above). However, these modes are not propagated in the core and couple directly into pedestal modes. Coupling into pedestal modes from core modes is exacerbated through fiber bending.

SRS occurs at a power known as the critical SRS power, and forms a forward-propagating Stokes-shifted wave. The presence of the signal and Stokes waves simultaneously leads to a highly efficient stimulated process.

Fiber bending can be used to inflict excess loss at the Stokes wavelength, thereby reducing its relative presence and thereby increasing the SRS threshold.

### SUMMARY

In order to exacerbate a bending loss, the present method and apparatus utilizes a fiber that has a modal index in the core that is greater than that of the pedestal at the desired signal wavelength. The present invention also comprises a fiber that has a modal index in the core that is less than that of the pedestal region at the Stokes (or Raman-shifted) wavelength. Therefore, the Raman signal will quickly couple into guided pedestal modes and much more efficiently through fiber bending.

The fiber can also have a starting point where the Stokes signal is guided by the core, but bending induces excess loss to this wavelength in such a structure as well.

In one embodiment of the present method and apparatus the fiber is a stimulated Raman scattering (SRS) suppressing optical fiber.

To reduce the effects of SRS in fibers, the fibers may have a significantly increased index of refraction over a cladding material, so that the fiber may be considered multimode or heavily doped.

### DESCRIPTION OF THE DRAWINGS

The features of the embodiments of the present method and apparatus are set forth with particularity in the appended claims. These embodiments may best be understood by reference to the following description taken in conjunction with the accompanying drawings, in the several figures of which like reference numerals identify like elements, and in which:

FIG. 1 is an index profile of a pedestal fiber. Typical dimensions are shown. Dual clad laser fibers have an additional low index polymer coating surrounding the pure silica cladding.

FIG. 2 is an RIP of a low-SRS fiber. Example dimensions are shown.

FIG. 3 is a modal index vs. wavelength graph for the fiber of FIG. 2. The index falls below that of the pedestal layer at a wavelength of about 1640 nm. Thus, the Raman signal is not guided well in the core, resulting in a significantly increased SRS threshold.

### DETAILED DESCRIPTION

While this invention is susceptible of embodiment in many different forms, there is shown in the drawings and described herein in detail a specific embodiment with the understanding that the present disclosure is to be considered as an exemplification of the principles of the invention and is not intended to limit the invention to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

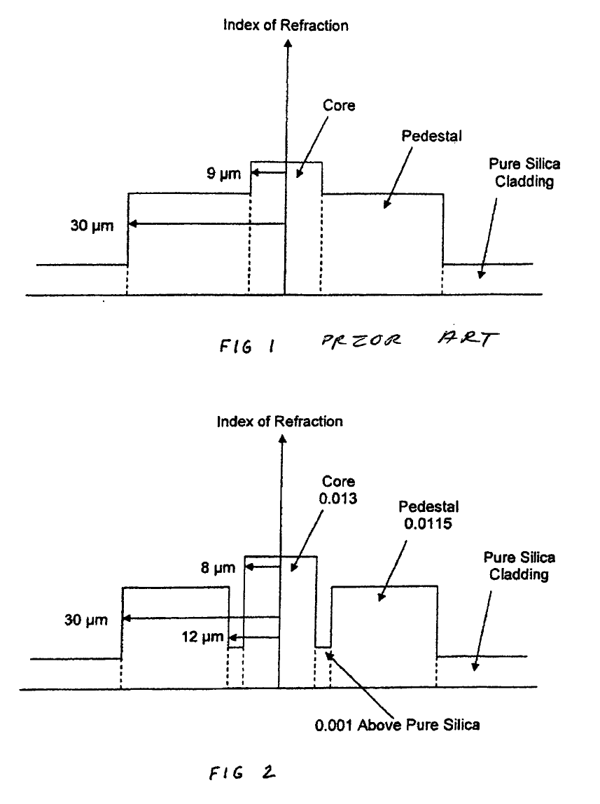

A RIP for an embodiment of the fiber that is contemplated is shown in FIG. 2. Of course, the present method and apparatus is not limited to such a particular fiber, but it would be considered an exemplification of the principles of the method and apparatus. The fiber is, for example, suitable for the realization of a reduced-SRS Yb/Er codoped LMA laser fiber. The additional structures, placed between the core and pedestal, serve to decrease the index of refraction of the Stokes signal. It will be obvious to those skilled in the art that any of the layers of this fiber can have larger or smaller diameters and higher or lower material index of refraction without departing significantly from the scope of this work. It will also be obvious to those skilled in the art that the fiber can be designed to target wavelengths other than those specified here.

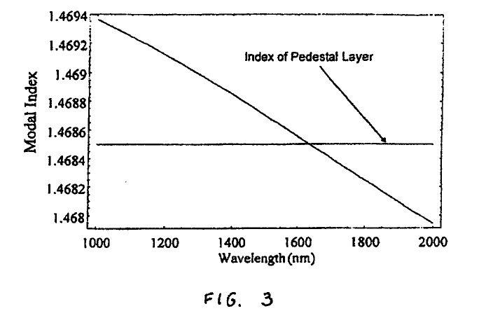

The fiber of this embodiment is designed to operate near 1550 nm. The Stokes signal wavelength is roughly 100 nm longer in wavelength (about 1650 nm). FIG. 3 shows the calculated index of refraction vs. optical wavelength for the fundamental mode of this fiber. It can be seen that the index of refraction falls below that of the pedestal layer at about 1640 nm. Bending this fiber will exacerbate the loss to the Stokes wavelength and significantly increase the SRS threshold.

It is also not necessary for the modal index to fall below that of the pedestal layer. Even if it is slightly larger, it is possible to induce substantially exacerbated bending losses to the Stokes wavelength. This may help minimize the bending loss on the desired signal wavelength, Furthermore, the profile shown in FIG. 2 is only one of many possible embodiments of a low-SRS fiber. For example, there can be more layers constituting the fiber of FIG. 2. Additionally, the index profile is not required to have square edges; it can be graded, linear, etc.

Furthermore, such a configuration is compatible with embodiments of low SBS fibers according to the present method and apparatus. Thus, this can lead to a fiber that is both SBS and SRS suppressing. The foregoing principles of the present method and apparatus are suitable for use with other rare earth dopants, including but not limited to Ytterbium, Erbium, Neodymium, and Thulium.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a fiber having a representative refractive index profile, the refractive index profile having at least a core and a pedestal; and
the fiber having a modal index in the core that is greater than a modal index of the pedestal at a predetermined signal wavelength, and wherein the modal index in the core is less than that of the pedestal region at the Stokes wavelength.

2. The apparatus of claim 1, wherein the predetermined signal wavelength is a wavelength of a Raman signal.

3. The apparatus of claim 1, wherein the fiber also has a starting point where the Raman signal is guided by the core, and wherein the Raman signal is thereafter coupled into guided pedestal modes.

4. The apparatus of claim 1, wherein the fiber is a stimulated Raman scattering suppressing optical fiber.

5. The apparatus of claim 1, wherein the fiber has a cladding, and wherein the fiber has a significantly increased index of refraction over a cladding material of the cladding to reduce effects of Stimulated Raman Scattering.

6. The apparatus of claim 1, wherein the fiber is multimode.

7. The apparatus of claim 1, wherein the additional structure is pure silicone.

8. The apparatus of claim 1, wherein the fiber is a reduced-SRS Yb/Er codoped LMA laser fiber.

9. The apparatus of claim 1, wherein the fiber has at least one additional structure located between the core and pedestal, the at least one additional structure serving to decrease an index of refraction of the Raman signal.

10. An apparatus, comprising:
a fiber having a representative refractive index profile;
the refractive index profile having at least a core and a pedestal;
an additional structure located between the core and the pedestal; and
a cladding located adjacent the pedestal opposed from the additional structure;
wherein the fiber has a modal index in the core that is greater than a modal index of the pedestal at a predetermined signal wavelength, and wherein the modal index in the core is less than that of the pedestal region at the Stokes wavelength.

11. The apparatus of claim 10, wherein the fiber operates near 1550 nm, wherein a Stokes signal wavelength is approximately 1650 nm, and wherein a bending of the fiber exacerbates a loss to the Stokes signal wavelength and increases a Stimulated Raman Scattering threshold.

12. The apparatus of claim 11, wherein the fiber has an index of refraction that falls below an index of refraction of the pedestal layer at about 1640 nm.

13. The apparatus of claim 10, wherein the refractive index profile has one of square edges, graded edges, linear edges and nonlinear edges.

14. The apparatus of claim 10, wherein the predetermined signal wavelength is a wavelength of a Raman signal.

15. The apparatus of claim 10, wherein the fiber also has a starting point where the Raman signal is guided by the core, and wherein the Raman signal is thereafter coupled into guided pedestal modes.

16. The apparatus of claim 10, wherein the fiber is a stimulated Raman scattering suppressing optical fiber.

17. The apparatus of claim 10, wherein the fiber has a cladding, and wherein the fiber has a significantly increased index of refraction over a cladding material of the cladding to reduce effects of Stimulated Raman Scattering.

18. The apparatus of claim 10, wherein the fiber is a reduced-SRS Yb/Er codoped LMA laser fiber.

19. The apparatus of claim 18, wherein the fiber is structured with rare earth dopants, including but not limited to Ytterbium, Erbium, Neodymium, and Thulium.

20. The apparatus of claim 10, wherein the additional structure is pure silicone.
